(19) United States
(12) Patent Application Publication
(10) Pub. No.: US 2003/0129870 A1
(43) Pub. Date: Jul. 10, 2003

(54) Miniature BNC connector assembly

(75) Inventors: Joe D. Norwood, Thousand Oaks, CA (US); James O. Handley, Thousand Oaks, CA (US); Anthony A. Hidalgo, Simi Valley, CA (US); Raymond W. Calvin, Northridge, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Trompeter Electronics, Inc.

(21) Appl. No.: 10/038,581

(22) Filed: Jan. 8, 2002

(51) Int. Cl. H01R 13/62

(52) U.S. Cl. 439/311

(57) ABSTRACT

A miniature BNC connector assembly having reduced dimensions includes a plug-side connector configured for engagement with a jack-side connector to form an electrical connection. The plug-side connector includes a plug-side connector body and a bayonet sleeve rotatably connected to the connector body. The bayonet sleeve has an outer diameter not greater than approximately half an inch.

### BACKGROUND OF THE INVENTION

1. Field of the Invention

The present invention relates generally to the field of electrical connectors. In particular, the present invention relates to a sizing of coaxial RF connectors.

2. Background Art

Electrical connectors provide couplings between electronic elements and/or devices. Many different types of electrical connectors exist and have been used to provide removable electrical connections between electronic elements and devices. On such type is RF (radio frequency) connectors.

Bayonet mechanisms are one way of securing such removable RF electrical connectors. One type of removable or separable electrical connector having a bayonet mechanism is known as a BNC or Bayonet Neil-Concelman mating connector pair. BNC mating connector pairs facilitate attachment of coaxial electrical cables to electronic elements or devices. Typical BNC mating connector pairs include a jack-side connector mounted to an electronic device or element and a plug-side connector connected to a cable. The jack-side connector typically includes a tubular cylindrical housing and a socket formed in a central location of the housing. The plug-side connector typically includes a tubular cylindrical connector body having a central contact formed in a central location of the connector body. The central contact of the plug-side connector is inserted into the socket of the jack-side connector and the connector body of the plug-side connector is inserted into the housing of the jack-side connector.

The jack-side connector also includes outwardly extending lugs formed on the outer surface of the housing. The plug-side connector includes a bayonet sleeve rotatably mounted on the outer surface of the connector body. The bayonet sleeve includes slots, which are typically J-shaped (J-slots), to mate with the lugs on the jack-side connector. The J-slots include an initial portion and a terminal portion. To connect the BNC mating connector pair, the slots in the bayonet sleeve first receive the lugs into the initial portion of the J-shaped slots, such that the mating connector pair is in a position of partial engagement. The bayonet sleeve is then rotated relative to the jack-side connector until the lugs slide into the terminal portion of the J-shaped slots. The mating connector pair is now in a fully engaged position, where the lugs are held and locked into the terminal portion of the J-shaped slots.

U.S. Pat. No. 4,037,909 to Trompeter et al. and U.S. Pat. No. 3,708,781 to Trompeter, which are herein incorporated by reference in their entirety, each disclose full-size BNC mating connector pairs. Further, BNC mating connector pairs are commercially available from Trompeter Electronics, Inc., Westlake Village, Calif. A common use of the Trompeter 75 ohm BNC mating connector pair is for telephone company central office DS3 applications. Full-size BNC mating connector pairs also see high volume use in the broadcast industry for providing high bandwidth connections between television broadcast equipment.

This twist-lock connection of the bayonet mechanism is a central feature of BNC connector pairs, and provides a convenient and reliable means for electrically connecting various electronic elements and devices. BNC connector pairs allow a reliable electrical connection to be made without the danger of the jack-side and plug-side connectors gradually working loose or becoming inadvertently unplugged.

The bayonet mechanism of BNC mating connector pairs provides a positive engagement between jack-side connectors and plug-side connectors. This positive engagement allows a user to determine whether a jack-side connector is fully engaged with a plug-side connector by attempting to manually rotate the bayonet sleeve (e.g., using his or her fingers). If substantial resistance is encountered, then the mating connector pair is fully engaged.

Large numbers of full-size BNC mating connector pairs are often positioned in close proximity (both vertically and horizontally) on network elements. Increased market demand for telephone lines (for voice, fax and data traffic) has caused additional crowding in telephone company central offices. It is desired to increase the density of connections on, for example, digital cross connect modules. However, the mechanical footprint of the standard BNC connector hinders further increases in connection densities.

Connectors, such as the SMB connector, with smaller footprints might be used, but they lack certain advantages (e.g., the bayonet locking feature and field crimpability) of BNC connectors, which have become an industry standard. Therefore, the present inventors have recognized that, what is needed, is a connector having the advantages of the BNC connector but having a smaller footprint to allow an increase in connector population density on, for example, network elements such as an OC-48 multiplexer or a DSX (digital cross connect).

### BRIEF SUMMARY OF THE INVENTION

The present invention is drawn to a plug-side connector and a jack-side connector in a mating connector pair, where the plug-side connector is configured for engagement with the jack-side connector to form an electrical connection, along with an electromagnetic field. The plug-side connector includes a plug-side connector body and a bayonet sleeve rotatably connected to the connector body. The bayonet sleeve has an outer diameter of approximately 0.5 inches or less.

The connector assembly of the present invention is smaller and more compact than previous connector assemblies, particularly full-size BNC mating connector pairs. The connector assembly of the present invention achieves an improvement of approximately 30 percent more interconnects per given area than full-size BNC mating connector pairs, while including all of the attributes of the standard full-size BNC connector, including the same reliability, materials, mechanical stability, 75 ohm impedance and return loss attributes. Further, the connector assembly of the present invention maintains the same tooling and installation processes and can be field-terminated using the same industry-standard cable strip tools, contact crimp tools, crimp sleeve crimp tools and termination practices as the full-size BNC connectors.

### BRIEF DESCRIPTION OF THE DRAWINGS/FIGURES

The foregoing and other features and advantages of the present invention will be apparent from the following, more particular description of a preferred embodiment of the invention, as illustrated in the accompanying drawings in which:

FIG. 1 is a top or side view of the mating connector pair of the present invention, including a jack-side connector and a plug-side connector;

FIG. 2 is a perspective front view of a jack-side connector in accordance with the present invention;

FIG. 3 is a cut-away perspective front view of a plug-side connector in accordance with the present invention;

FIG. 4 is a perspective view of a bayonet sleeve of a plug-side connector in accordance with the present invention;

FIG. 5 is a top or side view of the mating connector pair of the present invention depicting the plug-side connector in partial engagement with the jack-side connector, wherein the lugs of the jack-side connector are positioned in the initial portion of the slots of the plug-side connector in accordance with the present invention;

FIG. 6 is a top or side view of the mating connector pair of the present invention depicting the plug-side connector in full engagement with the jack-side connector, wherein the lugs of the jack-side connector are positioned in the terminal portion of the slots of the plug-side connector in accordance with the present invention;

FIG. 7 is a front view of a panel for 25 full-size BNC mating connector pairs in accordance with the present invention; and

FIG. 8 is a front view of a panel for 25 BNC mating connector pairs in accordance with the present invention.

### DETAILED DESCRIPTION OF THE INVENTION

A preferred embodiment of the present invention is now described with reference to the Figures, in which like reference numerals are used to indicate identical or functionally similar elements. Also in the Figures, the left most digit of each reference numeral corresponds to the Figure in which the reference numeral is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

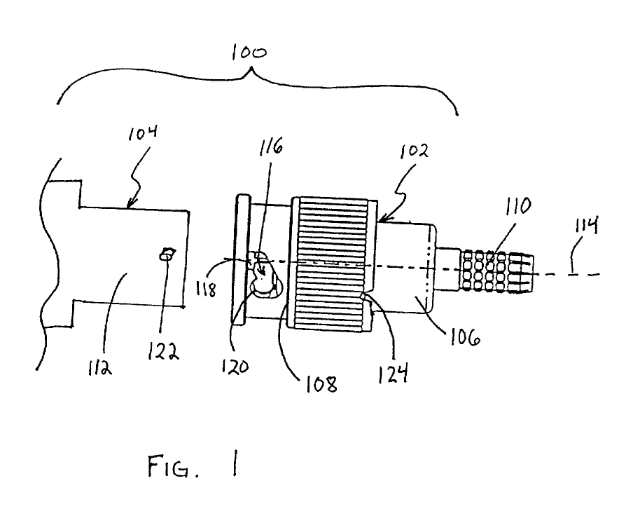

Miniature-BNC (M-BNC) mating connector pair 100 is shown in FIG. 1. M-BNC mating connector pairs are smaller than traditional full-size BNC mating connector pairs while still able to deliver the necessary impedance through a reliable and durable connection. In a preferred embodiment, mating connector pair 100 is a coaxial M-BNC mating connector pair having an impedance of approximately 75 ohms.

M-BNC mating connector pair 100 includes a plug-side connector 102 and a jack-side connector 104. Plug-side connector 102 is configured for engagement with jack-side connector 104 to form an electrical connection.

As shown in FIG. 1, the plug-side connector 102 includes a plug-side connector body 106, a bayonet sleeve 108, and a ferrule 110. Plug-side connector body 106 is configured for mating with a jack-side connector body 112 of jack-side connector 104 along a longitudinal axis 114. Bayonet sleeve 108 is rotatably mounted on plug-side connector body 106, and includes at least one slot 116, which is preferably J-shaped as shown in FIG. 1. The J-shaped slot (J-slot) 116 includes an initial portion 118 and a terminal portion 120. Slot 116 is configured and arranged for engagement with a lug 122 of jack-side connector body 112.

Jack-side connector 104 includes jack-side connector body 112 with lug 122 disposed on a peripheral surface of jack-side connector body 112. Jack-side connector 104 is inserted into plug-side connector 102 so that lug 122 is inserted into initial portion 118 of slot 116. Bayonet sleeve 108 is then rotated until plug-side connector 102 and jack-side connector 104 are fully engaged such that lug 122 rests in terminal portion 120 of slot 116.

Bayonet sleeve 108 further includes an indicator 124 located on bayonet sleeve 108. Indicator 124 aligns with lug 122 of jack-side connector body 112 when slot 116 of bayonet sleeve 108 is fully engaged with lug 122 (i.e., when lug 122 rests in terminal portion 120 of slot 116) to provide a visual indication of the secure connection. Indicator 124 is described in further detail in U.S. patent application Ser. No. 09/938,857 filed on Aug. 27, 2001, which is incorporated herein by reference.

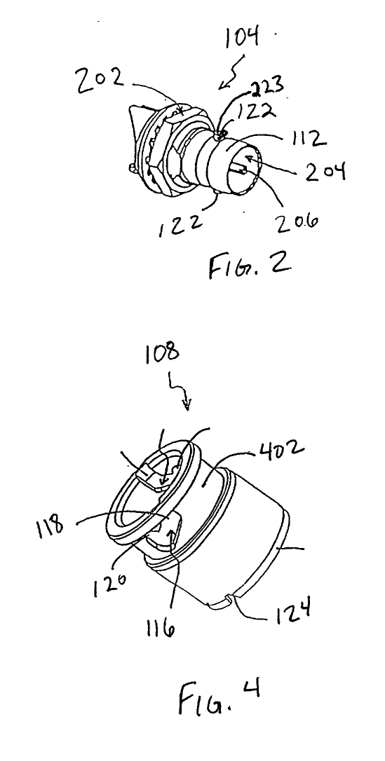

Jack-side connector 104, plug-side connector body 106 and bayonet sleeve 108 are more fully described with reference to FIGS. 2, 3 and 4.

FIG. 2 is a perspective front view of an M-BNC jack-side connector 104. Jack-side connector 104 includes a jack-side connector housing 202, jack-side connector body 112, a lumen 204, a jack-side conductor 206, a jack-side connector insulator (not shown), and lugs 122. Jack-side connector body 112 is preferably tubular and cylindrical and formed of a conductive material such as aluminum, beryllium copper, brass, zinc or stainless steel. In one embodiment, jack-side connector body 112 has an outer diameter between approximately 0.285 inches and approximately 0.305 inches, and further has an inner diameter between approximately 0.237 inches and approximately 0.257 inches. In a preferred embodiment, jack-side connector body 112 has an outer diameter of approximately 0.295 inches and an inner diameter of approximately 0.247 inches.

Lugs 122 are disposed on a peripheral surface of jack-side connector body 112. Lugs 122 are preferably cylindrical in shape and extend radially outward from the peripheral surface of jack-side connector body 112. In a preferred embodiment, jack-side connector 104 includes two lugs 122 positioned on jack-side connector body 112 approximately one hundred eighty degrees apart from one another. In an embodiment, the distance between the outermost surfaces of lugs 122 is between approximately 0.345 inches and 0.365 inches. In a preferred embodiment, the distance between the outermost surfaces of lugs 122 is approximately 0.355 inches.

Lumen 204 extends longitudinally through jack-side connector body 112. Jack-side conductor 206 is disposed within lumen 204, and is configured to mate with a plug-side conductor 302 (discussed below) of plug-side connector 102 to form an electrical connection. In an embodiment, jack-side conductor 206 is a female socket having an inner diameter between approximately 0.026 inches and approximately 0.032 inches. In a preferred embodiment, the female socket has an inner diameter of approximately 0.029 inches. A jack-side connector insulator (not visible from the figures) is preferably provided within lumen 204 and around jack-side conductor 206 to electrically isolate jack-side conductor 206 from jack-side connector body 112. In a preferred embodiment, the jack-side connector insulator is formed of polytetrafluoroethylene (PTFE) and has an outer diameter between approximately 0.157 inches and approximately 0.163 inches, and preferably approximately 0.160 inches.

FIG. 3 is a cut-away perspective front view of an M-BNC plug-side connector 102, including bayonet sleeve 108 and plug-side connector body 106. Plug-side connector body 106 is preferably tubular and cylindrical and formed of a conductive material such as aluminum, beryllium copper, brass, zinc or steel. Plug-side connector body 106 includes spring fingers 304, a plug-side conductor 302, and a plug-side connector insulator 303. Spring fingers 304 act to bias plug-side connector body 106 into engagement within jack-side connector body 112.

In an embodiment, plug-side connector body 106 has an average diameter between approximately 0.180 inches and approximately 0.194 inches. In a preferred embodiment, plug-side connector body 106 has an average diameter between approximately 0.183 inches and approximately 0.191 inches.

Plug-side conductor 302 is configured to mate with jack-side conductor 206. In an embodiment, plug-side conductor 302 is a male contact which mates with female socket 206 of jack-side connector 104, where the male contact has an outer diameter between approximately 0.026 inches and approximately 0.032 inches. In a preferred embodiment, the male contact has an outer diameter of approximately 0.029 inches. Plug-side connector insulator 303 is preferably provided around plug-side conductor 302 to electrically isolate plug-side conductor 302. In a preferred embodiment, plug-side connector insulator 303 is formed of PTFE and has an outer diameter between approximately 0.157 inches and approximately 0.163 inches, and preferably approximately 0.160 inches.

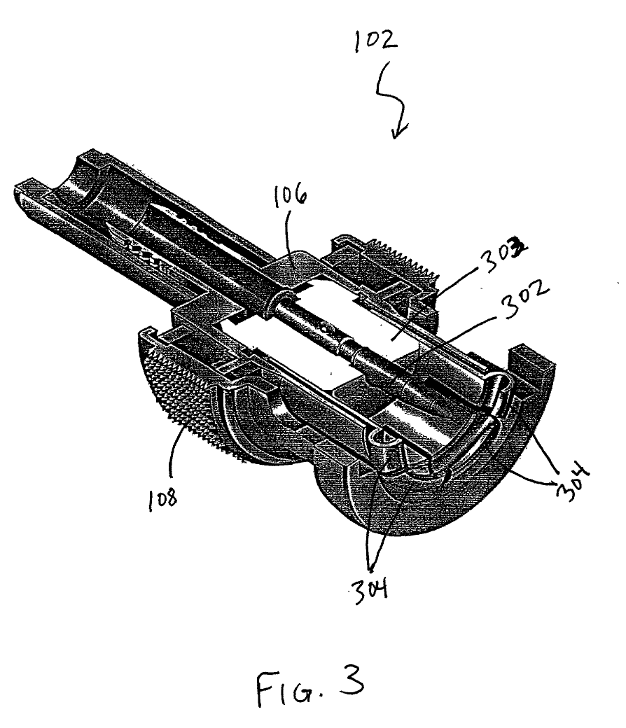

In an alternate embodiment, plug-side conductor 302 and jack-side conductor 206 may be reversed so that plug-side conductor 302 is a female socket, and jack-side conductor 206 is a male contact. In a preferred embodiment, plug-side connector body 106 mates with jack-side connector body 112 such that spring fingers 304 fit within lumen 204 and plug-side conductor 302 mates with jack-side conductor 206 to form an electrical connection. Bayonet sleeve 108 is discussed in greater detail below with reference to FIG. 4.

FIG. 4 is a perspective view of an M-BNC bayonet sleeve 108. Bayonet sleeve 108 is configured to be rotatably mounted on plug-side connector body 106, and includes a recessed portion 402, slots 116 and indicators 124. Sleeve 108 is preferably tubular and cylindrical and formed of a conductive material such as aluminum, beryllium copper, brass, zinc or stainless steel.

In one embodiment, bayonet sleeve 108 has an outer diameter not greater than approximately 0.5 inches, preferably between approximately 0.425 inches and approximately 0.484 inches. In a preferred embodiment, bayonet sleeve has an outer diameter between approximately 0.430 inches and approximately 0.445 inches, and preferably approximately 0.437 inches.

Bayonet sleeve has an inner diameter between approximately 0.300 inches and approximately 0.310 inches. In a preferred embodiment, bayonet sleeve has an inner diameter between approximately 0.303 inches and approximately 0.307 inches, and preferably approximately 0.305 inches.

Slots 116 are configured and arranged for engagement with lugs 122 of jack-side connector 104. In a preferred embodiment, sleeve 108 includes two slots 116 positioned on recessed portion 402 approximately one hundred eighty degrees apart from one another, corresponding to two lugs 122 positioned approximately one hundred eighty degrees apart from one another on jack-side connector body 112 (see FIG. 2). As shown in FIG. 4, slots 116 are substantially J-shaped. Although J-shaped slots are shown, in alternate embodiments, slots may be any type of suitable shape, as would be apparent to one skilled in the relevant art. J-shaped slots 116 include initial portions 118 and terminal portions 120, as shown in FIG. 4. As discussed above, slots 116 are configured and arranged to correspond and engage with lugs 122.

In a preferred embodiment, bayonet sleeve 108 includes at least one indicator 124. Indicator(s) 124 are aligned with a reference point, so that when slots 116 are fully engaged with lugs 122, indicator(s) 124 provide a visual indication that plug-side connector 102 is fully mated with jack-side connector 104. In a preferred embodiment, sleeve 108 includes two indicators 124 positioned on sleeve 108 approximately one hundred eighty degrees apart from one another, which correspond to two slots 116. In a preferred embodiment, indicator 124 is a V-shaped notch, as shown in FIG. 4. In alternate embodiments, indicator 124 may be a dimple on sleeve 108, or may be any other shape, size, or configuration, as would be known to one skilled in the relevant art.

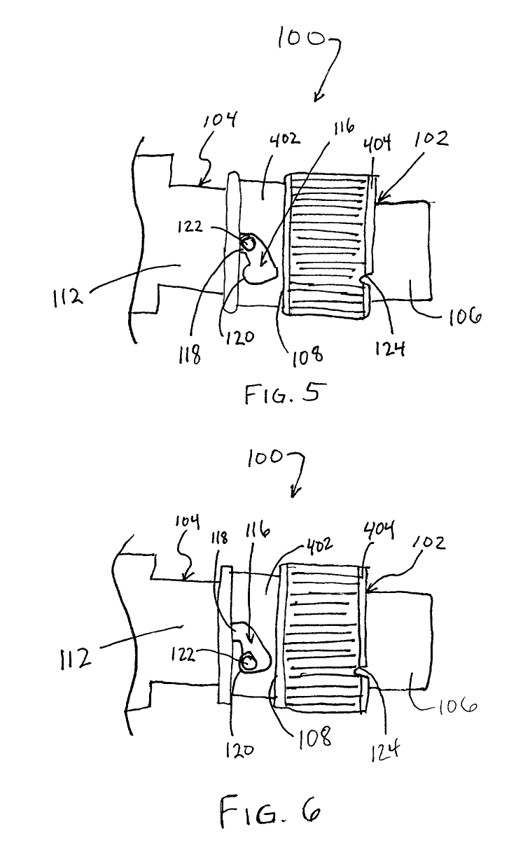

The mating and engagement of jack-side connector 104 and lugs 122 to plug-side connector 102 and slots 116 is further discussed with reference to FIGS. 5 and 6. As shown in FIG. 5, to mate plug-side connector 102 and jack-side connector 104, lugs 122 are aligned and inserted into corresponding slots 116. As shown in FIG. 5, when jack-side connector 104 is initially inserted into plug-side connector 102, lugs 122 are inserted into an initial portion 118 of slots 116. The slots 116 and lugs 122 are said to be partially engaged at this point. Next, plug-side connector 102 is pushed against jack-side connector 104 (depressing an internal spring member 306, described below, of plug-side connector 102) and bayonet sleeve 108 is rotated until lugs 122 are at the terminal portion 120 of slots 116, as shown in FIG. 6. The slots 116 and lugs 122 are said to be fully engaged at this point, because lugs 122 are now locked into position.

When plug-side connector 102 is inserted into jack-side connector 104, a leading peripheral edge 208 (see FIG. 2) of jack-side connector 104 will contact a spring element 306 (see FIG. 3) disposed between body 106 and bayonet sleeve 108 of plug-side connector 102. Spring element 306 is a circular washer that is made from a resilient, springy material such as beryllium copper or phosphoric bronze, and is formed in a “wave-shape” such that it is not flat unless compressed by an external force and will return to its wave-shape when the external force is removed. Spring element 306 provides a bias force to secure connector assembly 100 in the locked-position when lugs 122 of jack-side connector 104 are positioned in terminal positions 120 of bayonet sleeve 108.

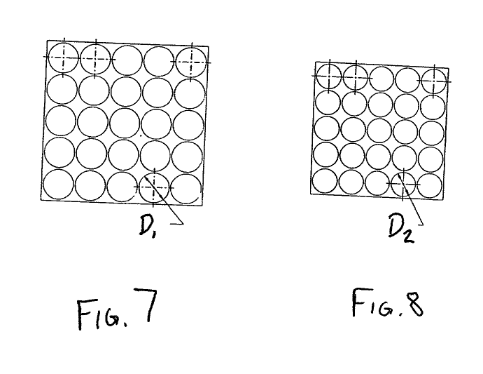

When mating connector pairs are used with telecommunications and broadcast equipment, large number of mating connector pairs are often used in close proximity to one another, both horizontally and vertically. Jack-side connectors are typically mounted on the case panels of electronic equipment. A front view of a typical panel for 25 full-size BNC mating connector pairs is shown in FIG. 7, where D1 is the outer diameter of the full-size BNC bayonet sleeve. The outer diameter D1 of full-size BNC mating connector pairs is typically approximately 0.593 inches. A housing for 25 full-size BNC mating connector pairs such as the housing shown in FIG. 7 will typically have the BNC mating connector pairs spaced so that the center-to-center length L1 is approximately 0.625 inches and the width W1 of each side of the housing is approximately 3.157 inches. Thus, a housing for 25 full-size BNC mating connector pairs such as the housing shown in FIG. 7 typically has an area of approximately 9.967 inches.

A front view of a panel for 25 M-BNC mating connector pairs 100 is shown in FIG. 8, where D2 is the outer diameter of the M-BNC bayonet sleeve. As described above, bayonet sleeve 108 preferably has an outer diameter between approximately 0.425 inches and approximately 0.484 inches. As shown in FIG. 8, the outer diameter D2 and the cross-sectional area of the panel for the M-BNC bayonet sleeve are considerably smaller than the outer diameter D1 and the cross-sectional area for the full-size BNC bayonet sleeve.

In a preferred embodiment, the center-to-center length L2 is approximately 0.516 inches and the width W2 of each side of the housing is approximately 2.612 inches. Thus, a housing for 25 M-BNC mating connector pairs such as the housing shown in FIG. 8 preferably has an area not greater than approximately seven inches. In a preferred embodiment, a housing for 25 M-BNC mating connector pairs will have an area of approximately 6.823 inches.

Thus, the M-BNC mating connector pairs of the present invention achieve an improvement of approximately 30 percent more interconnects per given area while including all of the attributes of the standard full-size BNC connector, including the same reliability, mechanical stability, 75 ohm impedance and return loss attributes as the full-size BNC connector.

While the invention has been particularly shown and described with reference to preferred embodiments thereof it will be understood by those skilled in the art that they have been presented by way of example only, and not limitation, and various changes in form and details can be made therein without departing from the spirit and scope of the invention. Thus, the breadth and scope of the present invention should not be limited by any of the above-described exemplary embodiments, but should be defined only in accordance with the following claims and their equivalents. Additionally, all references cited herein, including journal articles or abstracts, published or corresponding U.S. or foreign patent applications, issued U.S. or foreign patents, or any other references, are each entirely incorporated by reference herein, including all data, tables, figures, and text presented in the cited references.

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one of ordinary skill in the art.

What is claimed is:

1. A coaxial plug-side connector configured for engagement with a jack-side connector to form an electrical connection comprising:
a plug-side connector body;
a bayonet sleeve having an outer diameter not greater than approximately 0.5 inches and rotatably connected to said connector body, said sleeve having two slots therein for engagement with corresponding lugs on a jack-side connector;
a plug-side conductor disposed within a lumen of said plug-side connector body, said plug-side conductor being configured for mating with said jack-side conductor of said jack-side connector; and
a plug-side connector insulator electrically isolating said plug-side conductor from said plug-side connector body.

2. The plug-side connector of claim 1, wherein said plug-side connector has an average impedance of approximately 75 ohms.

3. The plug-side connector of claim 2, wherein said bayonet sleeve has an outer diameter between approximately 0.425 inches and approximately 0.484 inches.

4. The plug-side connector of claim 2, wherein said bayonet sleeve has an outer diameter between approximately 0.430 inches and approximately 0.445 inches.

5. The plug-side connector of claim 2, wherein said bayonet sleeve has an outer diameter of approximately 0.437 inches.

6. The plug-side connector of claim 2, wherein said plug-side connector insulator is formed of polytetrafluoroethylene.

7. The plug-side connector of claim 6, wherein said plug-side connector insulator has an outer diameter between approximately 0.157 inches and approximately 0.163 inches.

8. The plug-side connector of claim 2, wherein said plug-side conductor is a male contact pin.

9. The plug-side connector of claim 8, wherein said male contact pin has an outer diameter between approximately 0.026 inches and approximately 0.032 inches.

10. The plug-side connector of claim 2, further comprising a visual indicator being configured to align with a reference point when said slots in said sleeve are fully engaged with the lugs of a jack-side connector to provide a visual indication that the plug-side connector is fully engaged with the jack-side connector.

11. The plug-side connector of claim 2, wherein each of said slots in said sleeve comprises a J-shaped slot, and wherein said J-shaped slots are positioned on said sleeve approximately one hundred eighty degrees apart from one another.

12. The plug-side connector of claim 2, wherein said bayonet sleeve has an inner diameter between approximately 0.300 inches and approximately 0.310 inches.

13. The plug-side connector of claim 2, wherein said plug-side connector body has an average diameter between approximately 0.180 inches and approximately 0.194 inches.

14. A jack-side connector configured for engagement with a plug-side connector to form an electrical connection and having an impedance of approximately 75 ohms, comprising:
a jack-side connector body having an outer diameter between approximately 0.285 inches and approximately 0.305 inches, and having two lugs disposed on a peripheral surface thereof, said lugs being positioned on said jack-side connector body approximately one hundred eighty degrees apart from one another,
a jack-side conductor disposed within a lumen of said jack-side connector body; and
a jack-side connector insulator electrically isolating said jack-side conductor from said jack-side connector body.

15. The jack-side connector of claim 14, wherein said jack-side connector body has an inner diameter between approximately 0.237 inches and approximately 0.257 inches.

16. The jack-side connector of claim 14, wherein the distance between the outermost surfaces of said lugs is between approximately 0.345 inches and approximately 0.365 inches.

17. The jack-side connector of claim 14, wherein said plug-side conductor is a female socket.

18. The jack-side connector of claim 17, wherein said female socket has an outer diameter between approximately 0.026 inches and approximately 0.032 inches.

19. The jack-side connector of claim 14, wherein said jack-side connector insulator is formed of polytetrafluoroethylene.

20. The jack-side connector of claim 19, wherein said jack-side connector insulator has an outer diameter between approximately 0.157 inches and approximately 0.163 inches.

21. A mating connector pair comprising:
(a) a jack-side connector comprising
a jack-side connector body having two lugs disposed on a peripheral surface thereof, said lugs being positioned on said jack-side connector body approximately one hundred eighty degrees apart from one another,
a jack-side conductor disposed within a lumen of said jack-side connector body, and
a jack-side connector insulator electrically isolating said jack-side conductor from said jack-side connector body; and
(b) a plug-side connector comprising
a plug-side connector body, and
a bayonet sleeve having an outer diameter not greater than approximately 0.5 inches and rotatably connected to said connector body, said sleeve having two slots therein for engagement with corresponding lugs on a jack-side connector,
a plug-side conductor disposed within a lumen of said plug-side connector body, said plug-side conductor being configured for mating with said jack-side conductor of said jack-side connector, and
a plug-side connector insulator electrically isolating said plug-side conductor from said plug-side connector body.

22. The mating connector pair of claim 21, wherein the mating connector pair has an average impedance of approximately 75 ohms.

23. The mating connector pair of claim 22, wherein said bayonet sleeve has an outer diameter between approximately 0.425 inches and approximately 0.484 inches.

24. The mating connector pair of claim 22, wherein said bayonet sleeve has an outer diameter between approximately 0.430 inches and approximately 0.445 inches.
